(19) United States
(12) Patent Application Publication
(10) Pub. No.: US 2014/0137652 A1
(43) Pub. Date: May 22, 2014

(54) PRESSURE SENSOR CHIP

(71) Applicant: Azbil Corporation, Tokyo (JP)

(72) Inventors: Tomohisa TOKUDA, Tokyo (JP); Yoshiyuki ISHIKURA, Tokyo (JP); Yuuki SETO, Tokyo (JP)

(73) Assignee: AZBIL CORPORATION, Tokyo (JP)

(21) Appl. No.: 14/085,413

(22) Filed: Nov. 20, 2013

(30) Foreign Application Priority Data
Nov. 20, 2012 (JP) 2012-254727

(51) Int. Cl. G01L 7/08

(52) U.S. Cl. CPC G01L 7/082
USPC 73/715

(57) ABSTRACT

A pressure sensor chip includes a sensor diaphragm and first and second retaining members. In a peripheral edge portion of the first retaining member, of a region facing one face of the sensor diaphragm, a region on an outer peripheral side is a bonded region bonded to the one face of the sensor diaphragm, and a region on an inner peripheral side is a non-bonded region not bonded to the one face of the sensor diaphragm. In the peripheral edge portion of the first retaining member, a ring-shaped groove is formed protruding in a direction of a wall thickness of the first retaining member, continuous with the non-bonded region of the peripheral edge portion. The second retaining member is provided with a recessed portion that prevents excessive dislocation of the sensor diaphragm when an excessively large pressure is applied to the sensor diaphragm.

### CROSS REFERENCE TO RELATED APPLICATION

This application claims priority under 35 U.S.C. §119 to Japanese Patent Application No. 2012-254727, filed on Nov. 20, 2012, the entire content of which being hereby incorporated herein by reference.

### FIELD OF TECHNOLOGY

The present invention relates to a pressure sensor chip that uses a sensor diaphragm that outputs a signal in accordance with a difference in pressures borne by one face and by another face thereof, for example, a pressure sensor chip wherein a strain resistance gauge is formed on a thin plate-shaped diaphragm that deforms when bearing pressure, to detect, from a change in the resistance value of a strain resistance gauge that is formed on the diaphragm, the pressure that is applied to the diaphragm.

### BACKGROUND

Conventionally, differential pressure sensors that incorporate pressure sensor chips that use sensor diaphragms for outputting signals in accordance with differences between pressures borne on one face and borne on the other face have been used as differential pressure sensors for industrial use. These differential pressure sensors are structured so as to guide the respective measurement pressures, which will act on high-pressure-side and low-pressure-side pressure bearing diaphragms, to one side face and the other side face of a sensor diaphragm, through a filling liquid as a pressure transmitting medium, so as to detect the deformation of the sensor diaphragm as, for example, a change in a resistance value of a strain resistance gauge, to convert this change in the resistance value into an electric signal, so as to be outputted to the outside.

This type of differential pressure sensor is used when measuring, for example, a liquid surface height through detecting a pressure difference between two locations, upper and lower, with in a sealed tank for storing a fluid that is to be measured, such as a high-temperature reaction tower in an oil refining plant.

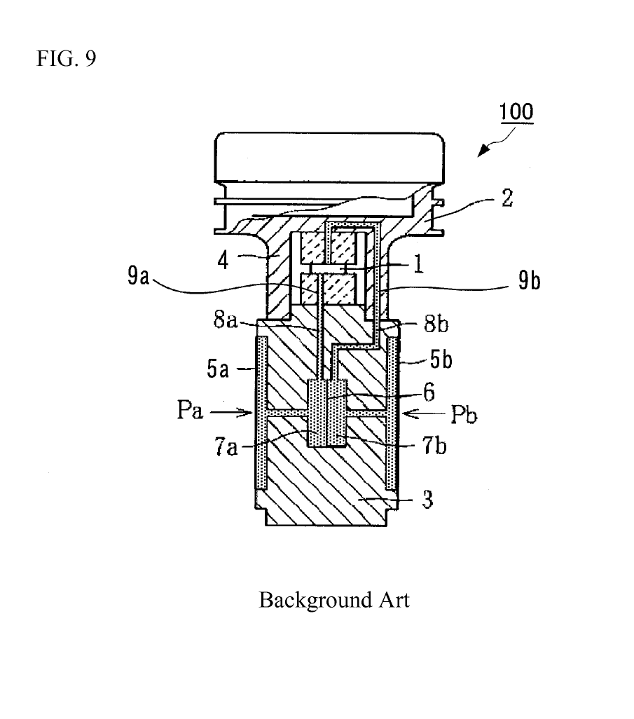

FIG. 9 is illustrates a schematic structure for a conventional differential pressure sensor. This differential pressure sensor 100 is structured through incorporating, in a meter body 2, a pressure sensor chip 1 having a sensor diaphragm (not shown). The sensor diaphragm in the pressure sensor chip 1 is made from silicon, glass, or the like, and a strain resistance gauge is formed on a surface of the diaphragm, which is formed in a thin plate shape. The meter body 2 is structured from a main unit portion 3, made out of metal, and a sensor portion 4, where a pair of barrier diaphragms (pressure bearing diaphragms) 5a and 5b, which are pressure bearing portions, is provided on a side face of the main unit portion 3, and the pressure sensor chip 1 is incorporated in the sensor portion 4.

In the meter body 2, the pressure sensor chip 1 that is incorporated in the sensor portion 4 is connected to the barrier diaphragms 5a and 5b that are provided in the main unit portion 3 through respective pressure buffering chambers 7a and 7b, which are separated by a large-diameter center diaphragm 6, and pressure transmitting media 9a and 9b, such as silicone oil, or the like, are filled into connecting ducts 8a and 8b, which connect the pressure sensor chip 1 to the barrier diaphragms 5a and 5b.

Note that the pressure transmitting medium, such as the silicone oil, is required because it is necessary to separate the strain (pressure)-sensitive sensor diaphragm from the corrosion-resistant pressure bearing diaphragms, in order to prevent foreign materials within the measurement medium from becoming adhered to the sensor diaphragm, and to prevent corrosion of the sensor diaphragm.

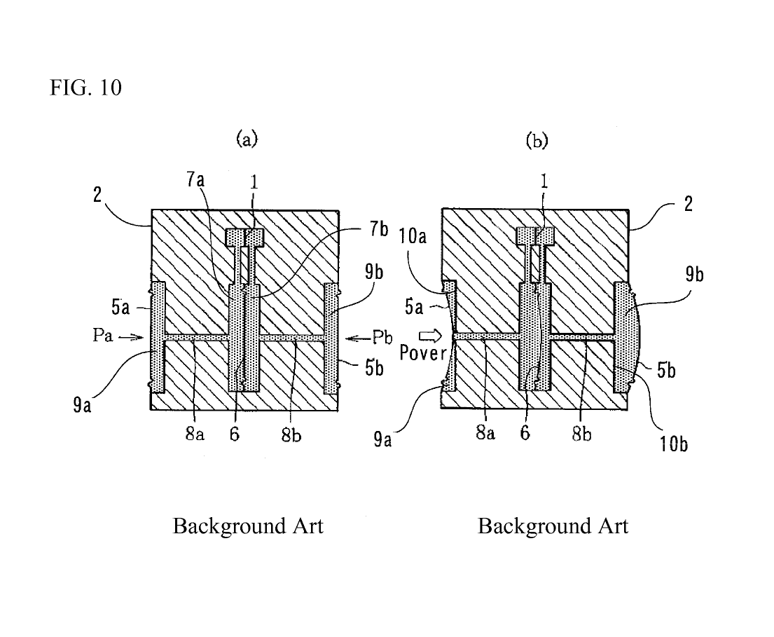

In this differential pressure sensor 100, a first fluid pressure (first measurement pressure) Pa from a process is applied to the barrier diaphragm 5a, and a second fluid pressure (second measurement pressure) Pb, from the process, is applied to the barrier diaphragm 5b, as in the operating state during proper operation that is illustrated schematically in FIG. 10(a). As a result, the barrier diaphragms 5a and 5b undergo dislocation, and the pressures Pa and Pb that are applied thereto are directed to the one face and the other face of the sensor diaphragm of the pressure sensor chip 1, by the pressure transmitting media 9a and 9b, through pressure buffering chambers 7a and 7b that are divided by the center diaphragm 6. The result is that the sensor diaphragm of the pressure sensor chip 1 undergoes dislocation in accordance with the pressure differential ΔP between the pressures Pa and Pb that are directed thereto.

In contrast, if, for example, an excessively large pressure Pover is applied to the barrier diaphragm 5a, then, as illustrated in FIG. 10(b), the barrier diaphragm 5a undergoes a large dislocation, and the center diaphragm 6 undergoes dislocation in accordance therewith so as to absorb the excessively large pressure Pover. Given this, the barrier diaphragm 5a arrives at the bottom face (an excessive pressure guard face) of a recessed portion 10a of the meter body 2, controlling the dislocation thereof, and preventing the propagation of a greater differential pressure ΔP than that to the sensor diaphragm through the barrier diaphragm 5a. When an excessively large pressure Pover is applied to the barrier diaphragm 5b as well, as with the case wherein an excessively large pressure Pover is applied to the barrier diaphragm 5a, the barrier diaphragm 5b arrives at the bottom face (an excessive pressure guard face) of a recessed portion 10b of the meter body 2, controlling the dislocation thereof, and preventing the propagation of a greater differential pressure ΔP than that to the sensor diaphragm through the barrier diaphragm 5b. The result is that breakage of the pressure sensor chip 1, that is, breakage of the sensor diaphragm in the pressure sensor chip 1, due to the application of an excessively large pressure Pover is prevented in advance.

In this differential pressure sensor 100, the pressure sensor chip 1 is enclosed within the meter body 2, thus making it possible to protect the pressure sensor chip 1 from the outside corrosive environment, such as the process fluid. However, because the structure is one wherein the center diaphragm 6 and the recessed portions 10a and 10b are provided for controlling the dislocation of the barrier diaphragms 5a and 5b to protect the pressure sensor chip 1 from excessively large pressures Pover thereby, the dimensions thereof unavoidably must be increased.

Given this, there has been a proposal for a structure for preventing breakage/rupture of the sensor diaphragm through preventing excessive dislocation of the sensor diaphragm, when an excessively large pressure is applied, through the provision of a first stopper member and a second stopper member, and having recessed portions of the first stopper member and the second stopper member face the one face side and the other face side of the sensor diaphragm. See, for example, Japanese Unexamined Patent Application Publication No. 2005-69736 (“the JP '736”).

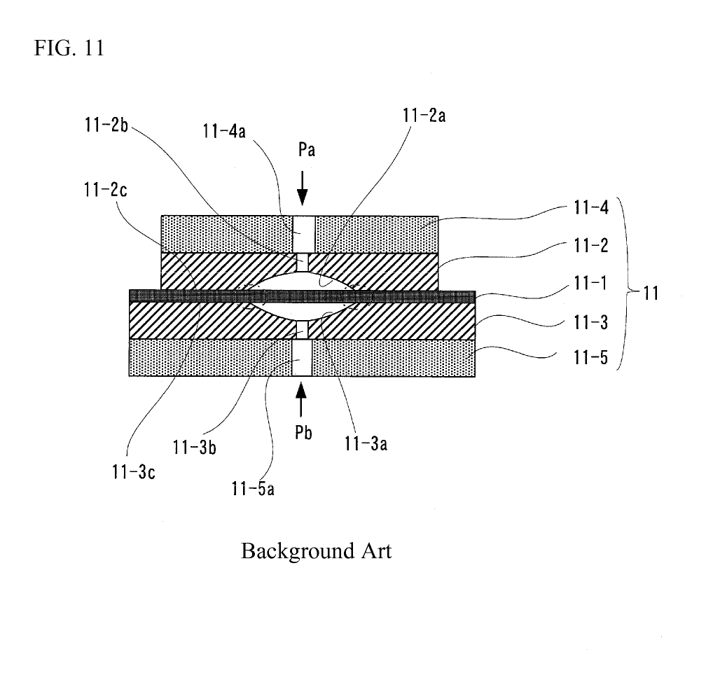

FIG. 11 illustrates schematically a pressure sensor chip that uses the structure illustrated in the JP '736. In this figure: 11-1 is a sensor diaphragm; 11-2 and 11-3 are first and second stopper members that are bonded with the sensor diaphragm 11-1 interposed therebetween; and 11-4 and 11-5 are first and second pedestals to which the stopper members 11-2 and 11-3 are bonded. The stopper members 11-2 and 11-3 and the pedestals 11-4 and 11-5 are structured from silicon, glass, or the like.

In this pressure sensor chip 11, recessed portions 11-2a and 11-3a are formed in the stopper members 11-2 and 11-3, where the recessed portion 11-2a of the stopper member 11-2 faces the one face of the sensor diaphragm 11-1, and the recessed portion 11-3a of the stopper member 11-3 faces the other face of the sensor diaphragm 11-1. The recessed portions 11-2a and 11-3a have surfaces that are curved along the dislocation of the sensor diaphragm 11-1, where pressure guiding holes 11-2b and 11-3b are formed at the apex portions thereof. Pressure introducing holes 11-4a and 11-5a are formed in the pedestals 11-4 and 11-5 as well, at positions corresponding to those of the pressure guiding holes 11-2b and 11-3b of the stopper members 11-2 and 11-3.

When such a pressure sensor chip 11 is used, then when there is a displacement of the sensor diaphragm 11-1 when an excessively large pressure is applied to the one face of the sensor diaphragm 11-1, the entirety of the dislocated face is supported and stopped by the curved surface of the recessed portion 11-3a of the stopper member 11-3. Moreover, then when there is a displacement of the sensor diaphragm 11-1 when an excessively large pressure is applied to the other face of the sensor diaphragm 11-1, the entirety of the dislocated face is supported and stopped by the curved surface of the recessed portion 11-2a of the stopper member 11-2.

This effectively prevents accidental rupturing of the sensor diaphragm 11-1 due to the application of an excessively large pressure, through preventing excessive dislocation when an excessively large pressure is applied to the sensor diaphragm 11-1, by preventing a concentration of stresses on the peripheral edge portion of the sensor diaphragm 11-1, thus enabling an increase in the excessively large pressure guard operating pressure (withstand pressure). Moreover, in the structure illustrated in FIG. 9, the center diaphragm 6 and the pressure buffering chambers 7a and 7b are eliminated, and the measurement pressures Pa and Pb are guided directly from the barrier diaphragms 5a and 5b to the sensor diaphragm 11-1, thus making it possible to achieve a reduction in the size of the meter body 2.

However, in the structure of the pressure sensor chip 11 illustrated in FIG. 11, the entirety of the faces of the peripheral edge portions 11-2c and 11-3c of the stopper members 11-2 and 11-3 are bonded to the one face and the other face of the sensor diaphragm 11-1. That is, the peripheral edge portion 11-2c that surrounds the recessed portion 11-2a of the stopper member 11-2 faces one face of the sensor diaphragm 11-1, and the entire region of this oppositely-facing peripheral edge portion 11-2c is bonded directly to the one face of the sensor diaphragm 11-1. Moreover, the peripheral edge portion 11-3c that surrounds the recessed portion 11-3a of the stopper member 11-3 faces the other face of the sensor diaphragm 11-1, and the entire region of this oppositely-facing peripheral edge portion 11-3c is bonded directly to the other face of the sensor diaphragm 11-1.

With this structure, when an excessively large pressure that exceeds the excessively large pressure guarding operation pressure (the withstand pressure) by the stopper member 11-2 is applied, then after the sensor diaphragm 11-1 flexes to arrive at the bottom of the recessed portion 11-2a of the stopper member 11-2, in this state the sensor diaphragm 11-1 further flexes along with the stopper member 11-2. Given this, there is a problem that the vicinity of the edge (the position surrounded by the dotted line in FIG. 11) of the sensor diaphragm 11-1 on the side to which the pressure is applied, where the greatest tensile stress is produced, will be in a constrained state on both sides, thus causing a concentration of stress at that location, making it impossible to secure the expected withstand pressure.

Furthermore, when there is a mismatch, in manufacturing, in the opening sizes of the recessed portions 11-2a and 11-3a of the stopper members 11-2 and 11-3, there will be misalignment of the locations of constraints on the sensor diaphragm 11-1, with the effect thereof sometimes causing more pronounced concentration of stresses. In this case, the concentration of stresses is much more severe following the sensor diaphragm 11-1 arriving at the bottom, presenting the risk of a further reduction in withstand pressure.

The present invention was created in order to solve such a problem, and an aspect thereof is to provide a pressure sensor chip able to secure the expected withstand pressure by reducing the stresses due to constraints on the diaphragm, to prevent the concentration of stresses at the diaphragm edges.

### SUMMARY

The present invention, in order to achieve the aspect set forth above, provides a pressure sensor chip including a sensor diaphragm that outputs a signal in accordance with a difference in pressures applied to one face and to another face, and first and second retaining members, which face and are bonded to the peripheral edge portions of the one face and the other face of the sensor diaphragm. In the peripheral edge portion of the first retaining member, of the region facing the one face of the sensor diaphragm the region on the outer peripheral side is a bonded region that is bonded to the one face of the sensor diaphragm, and the region on the inner peripheral side is a non-bonded region that is not bonded to the one face of the sensor diaphragm. In the peripheral edge portion of the first retaining member, a ring-shaped groove is formed protruding in the direction of the wall thickness of the first retaining member, continuous with the non-bonded region of the peripheral edge portion. The second retaining member is provided with a recessed portion that prevents excessive dislocation of the sensor diaphragm when an excessively large pressure is applied to the sensor diaphragm.

Given this invention, when a high pressure is applied to one face of the sensor diaphragm, the sensor diaphragm is able to flex without producing an excessive tensile stress, due to a constraint from the first retaining member, in the non-bonded region with the peripheral edge portion of the first retaining member, thereby making it possible to reduce the stress that is produced at this part. Moreover, the stress is dispersed in the interior of the ring-shaped groove that is continuous with the non-bonded region, making it possible to prevent a concentration of stresses in the diaphragm edges.

In the present invention, when the face of the sensor diaphragm that will bear the high-pressure-side measurement pressure is determined reliably, then the one face of the sensor diaphragm is used as the pressure bearing surface for the high-pressure-side measurement pressure, and the other face is used as the pressure bearing face for the low-pressure-side measurement pressure. That is, when the side that will bear the high-pressure-side measurement pressure in the sensor diaphragm is determined reliably, the one face of the sensor diaphragm is defined as the pressure bearing surface for the high-pressure-side measurement pressure, the region on the outside of the peripheral edge portion of the first retaining member, which is bonded to the one face of the sensor diaphragm, is defined as a bonded region, and the region on the inside is defined as a non-bonded region.

In the present invention, the first retaining member may be provided with a recessed portion for stopping excessive dislocation of the sensor diaphragm when an excessively large pressure is applied to the sensor diaphragm, and, for the peripheral edge portion of the second retaining member as well, as with the peripheral edge portion of the first retaining member, the region on the outer periphery side of the region that faces the other face of the sensor diaphragm may be defined as a bonded region that is bonded to the other face of the sensor diaphragm, and the region on the inner periphery side may be defined as a non-bonded region with the other face of the sensor diaphragm, and a ring-shaped groove that extends in the direction of wall thickness of the second retaining member may be formed continuously with the non-bonded region. Doing this enables the sensor diaphragm to flex without producing excessive tensile stress, due to the constraint of the retaining member, because of the non-bonded region with the peripheral edge portion of the retaining member on the high-pressure side, regardless of which of the faces of the sensor diaphragm is the pressure bearing surface for the high-pressure side for the measurement pressure, thus making it possible to reduce the stress that is produced in this part. Moreover, the stress is dispersed in the interior of the ring-shaped groove that is continuous with the non-bonded region, making it possible to prevent a concentration of stresses in the diaphragm edges.

In the present invention, the non-bonded region of the peripheral edge portion of the first retaining member need only be a region that is not bonded, and may or may not be in contact with the first face of the sensor diaphragm. For example, surfaces may be roughened through plasma or a chemical solution to form a region wherein, although contact is made with the one face of the sensor diaphragm, they do not bond to each other. Moreover, it may be formed as a small step that is established as no more than a specific proportion relative to the thickness of the sensor diaphragm.

In the present invention, the region on the outer peripheral side of the region of the peripheral edge portion of the first retaining member, which faces one face of the sensor diaphragm, is defined as a bonded region that is bonded to the one face of the sensor diaphragm, and the region on the inner peripheral side is defined as a non-bonded region with the one face of the sensor diaphragm, and a ring-shaped groove that extends in the direction of thickness of the second retaining member is formed continuously with the non-bonded region, and a recessed portion for preventing excessive dislocation of the sensor diaphragm when an excessively large pressure is applied to the sensor diaphragm is provided in the second retaining member, thus making it possible to reduce the occurrence of stress, due to constraints on the sensor diaphragm, and possible to prevent the concentration of stresses on the diaphragm edges, thus making it possible to secure the anticipated withstand pressure.

BRIEF DESCRIPTIONS OF THE DRAWINGS

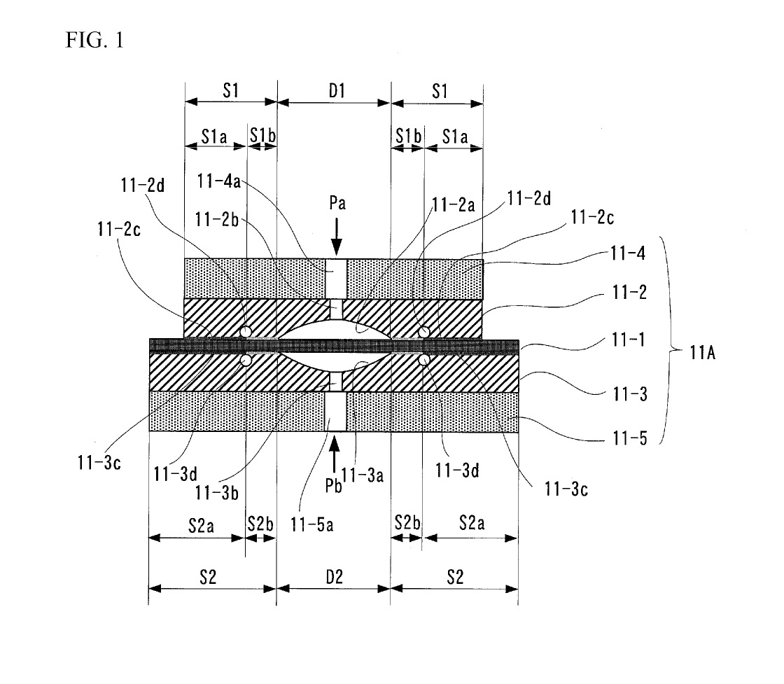

FIG. 1 is a diagram illustrating schematically Example of a pressure sensor chip according to the present invention.

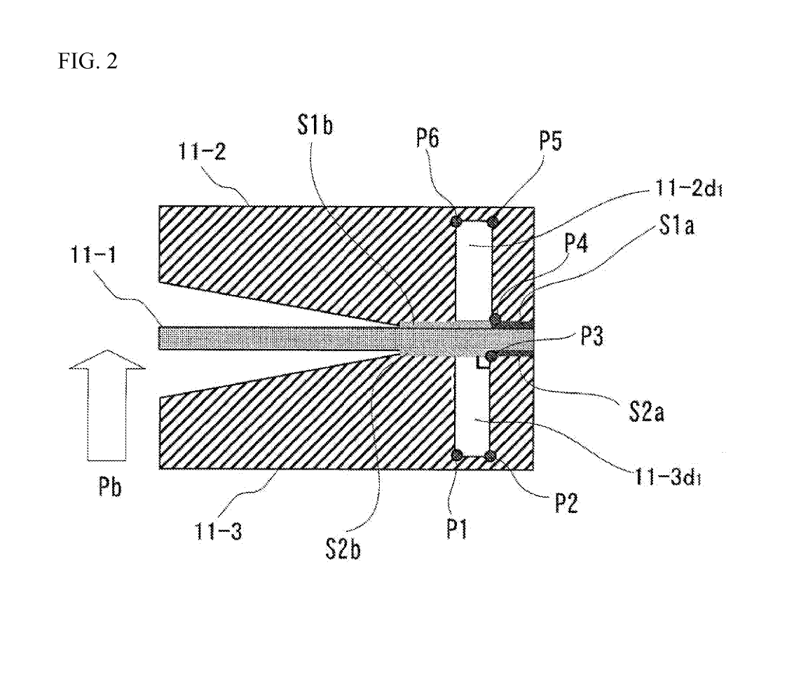

FIG. 2 is a diagram illustrating an example of the ring-shaped groove being a slit-shaped (a rectangular cross-sectional surface) ring-shaped groove, in this pressure sensor chip.

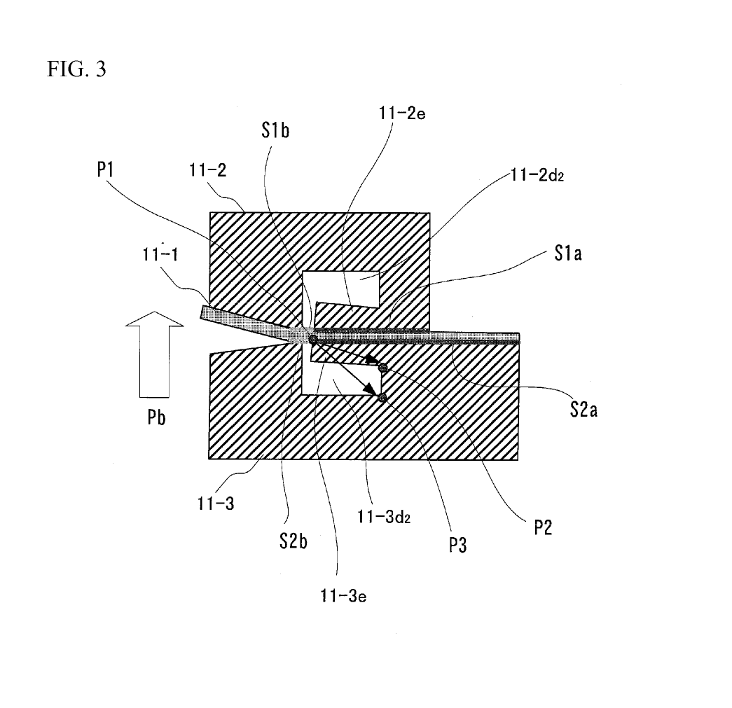

FIG. 3 is a diagram illustrating an example of the ring-shaped groove being an L-shaped (a L-shaped cross-sectional surface) ring-shaped groove, in this pressure sensor chip.

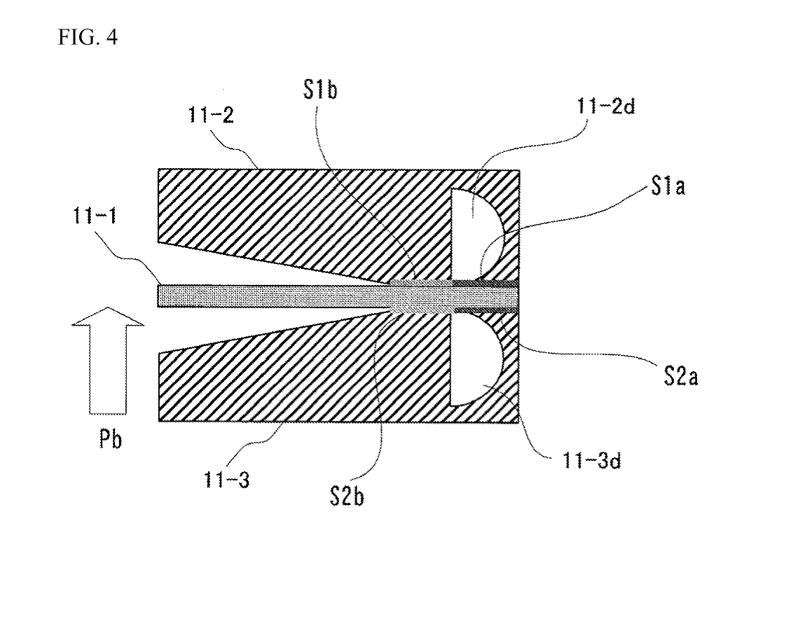

FIG. 4 is a diagram illustrating an example of the ring-shaped groove being a semicircular (a semicircular cross-sectional surface) ring-shaped groove, in this pressure sensor chip.

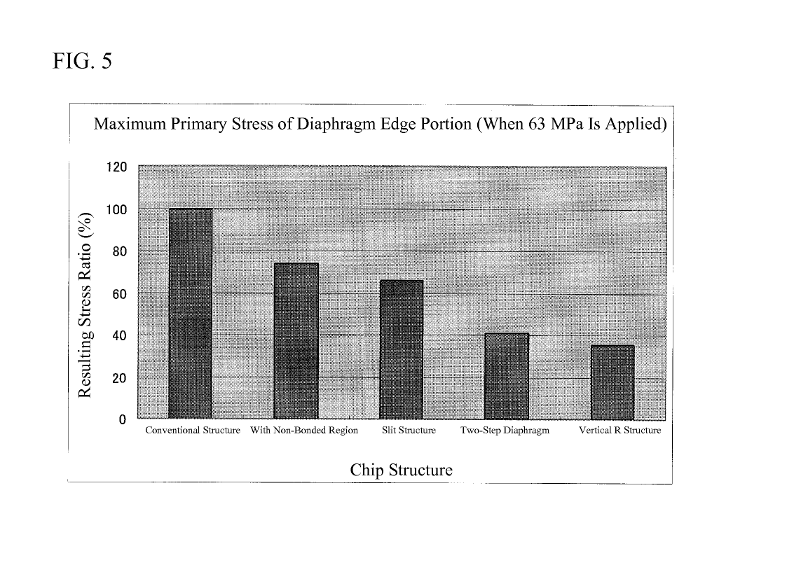

FIG. 5 is a diagram illustrating the proportions of stress produced at the diaphragm edges, comparing individual structures with the case of the conventional structure being defined as 100%.

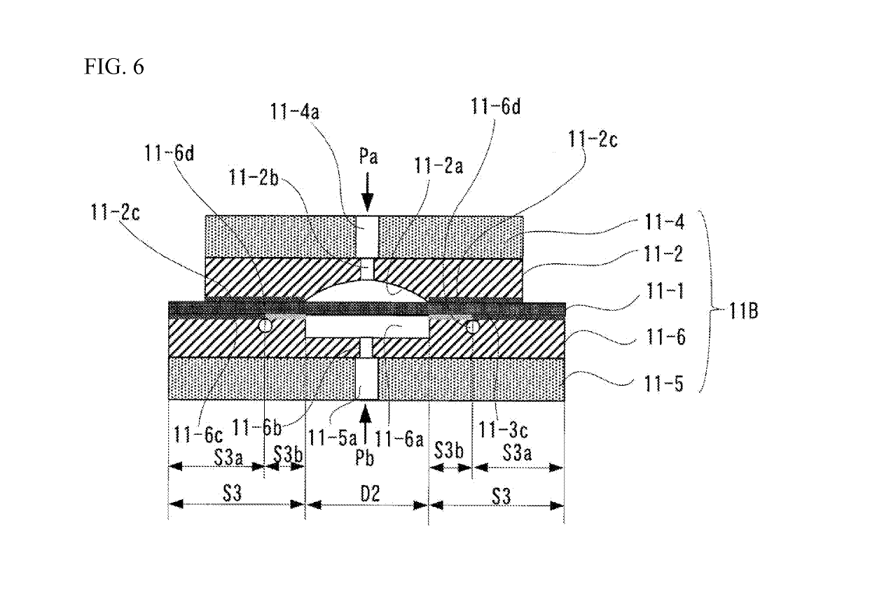

FIG. 6 is a diagram illustrating schematically Another Example of a pressure sensor chip according to the present invention.

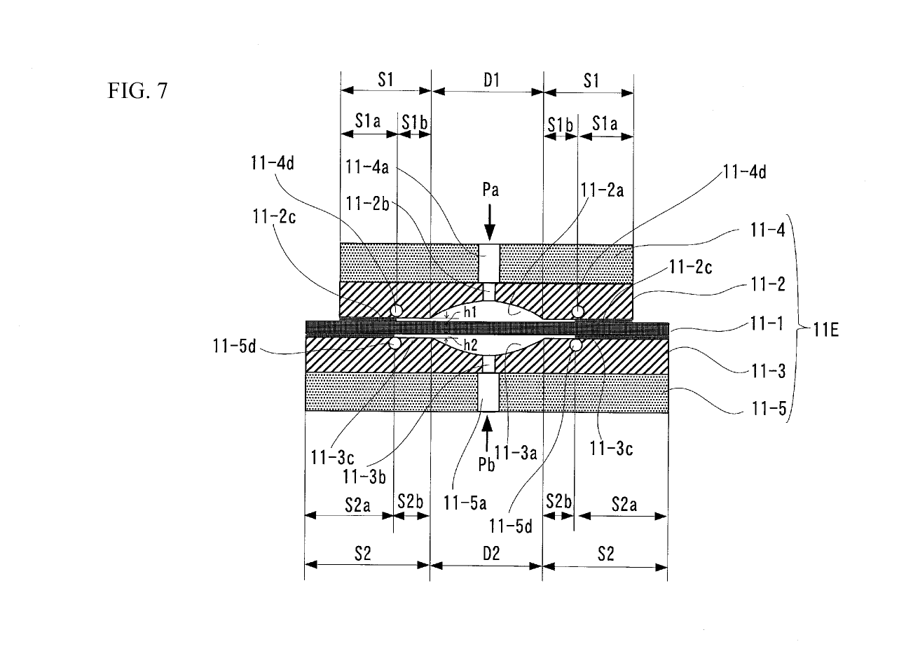

FIG. 7 is a diagram illustrating schematically Yet Another Example of a pressure sensor chip according to the present invention.

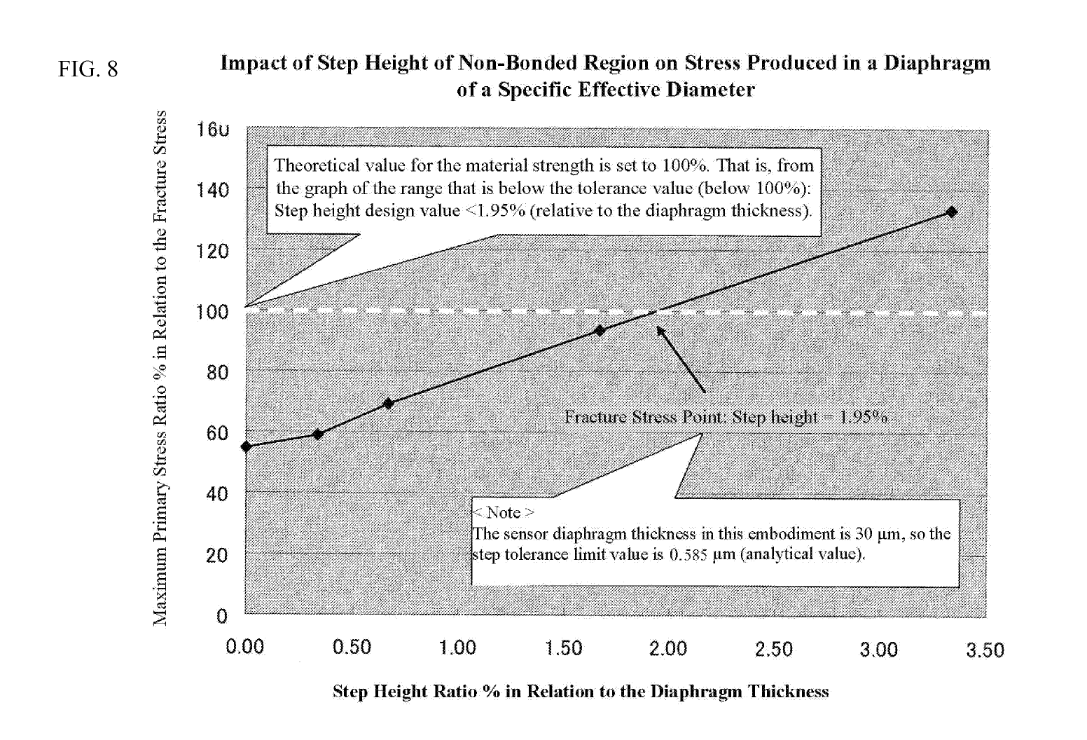

FIG. 8 is a diagram showing the relationship of the proportion (%) of the step height relative to the diaphragm thickness of the peripheral edge portion of the stopper member to the proportion (%) of the maximum primary stress relative to the fracture stress in the Yet Another Example.

FIG. 9 is a diagram illustrating a schematic structure of a conventional differential pressure sensor.

FIG. 10 is a diagram illustrating schematically a state of operation of the conventional differential pressure sensor.

FIG. 11 is a diagram illustrating schematically a pressure sensor chip that uses the structure illustrated in the JP '736.

### DETAILED DESCRIPTION

Examples according to the present invention will be explained below in detail, based on the drawings.

### Example

FIG. 1 is a diagram illustrating schematically Example of a pressure sensor chip according to the present invention. In this figure, codes that are the same as those in FIG. 11 indicate identical or equivalent structural elements as the structural elements explained in reference to FIG. 11, and explanations thereof are omitted. Note that, in this example, the pressure sensor chip is indicated by the code 11A, to differentiate from the pressure sensor chip 11 illustrated in FIG. 11.

In the pressure sensor chip 11A, the peripheral edge portion 11-2c of the stopper member 11-2 has, in the region S1 that faces the one face of the sensor diaphragm 11-1, an outer peripheral side region S1a that is a bonded region, bonded to the one face of the sensor diaphragm 11-1, and an inner peripheral side region S1b, that is a non-bonded region, not bonded to the one face side of the sensor diaphragm 11-1. Moreover, the peripheral edge portion 11-3c of the stopper member 11-3 has, in the region S2 that faces the other face of the sensor diaphragm 11-1, an outer peripheral side region S2a that is a bonded region, bonded to the other face of the sensor diaphragm 11-1, and an inner peripheral side region S2b, that is a non-bonded region, not bonded to the other face side of the sensor diaphragm 11-1.

The outer peripheral side region S1a of the peripheral edge portion 11-2c of the stopper member 11-2 is made into a bonded region through being bonded directly to the one face side of the sensor diaphragm 11-1, and the outer peripheral side region S2a of the peripheral edge portion 11-3c of the stopper member 11-3 is made into a bonded region through being bonded directly to the other face side of the sensor diaphragm 11-1. In the below, the region S1a of the outer peripheral side of the peripheral edge portion 11-2c of the stopper member 11-2 shall be termed the bonded region S1a, and the region S2a of the outer peripheral side of the peripheral edge portion 11-3c of the stopper member 11-3 shall be termed the bonded region S2a.

The region S1b on the inner peripheral side of the peripheral edge portion 11-2c of the stopper member 11-2 has the surface roughened, or the like, through plasma or a chemical solution, or the like, so that it will be a non-bonded region that will not bond even if it contacts the one face side of the sensor diaphragm 11-1. The region S2b on the inner peripheral side of the peripheral edge portion 11-3c of the stopper member 11-3 has the surface roughened, or the like, through plasma or a chemical solution, or the like, so that it will be a non-bonded region that will not bond even if it contacts the other face side of the sensor diaphragm 11-1. In the below, the region S1b of the inner peripheral side of the peripheral edge portion 11-2c of the stopper member 11-2 shall be termed the non-bonded region S1b, and the region S2b of the inner peripheral side of the peripheral edge portion 11-3c of the stopper member 11-3 shall be termed the non-bonded region S2b.

Moreover, a ring-shaped groove 11-2d, that extends in the direction of wall thickness of the stopper member 11-2 is formed continuously with the non-bonded region S1b of the peripheral edge portion 11-2c in the peripheral edge portion 11-2c of the stopper member 11-2, and a ring-shaped groove 11-3d, that extends in the direction of wall thickness of the stopper member 11-3 is formed continuously with the non-bonded region S2b of the peripheral edge portion 11-3c in the peripheral edge portion 11-3c of the stopper member 11-3. These ring-shaped grooves 11-2d and 11-3d are not grooves that are broken up discontinuously, but rather are continuous grooves, and preferably they have small opening widths, and the radii of the cross-sections of the grooves are large.

In this pressure sensor chip 11A, the region further toward the inside from the non-bonded region S1b on the top face of the sensor diaphragm 11-1 is used as the pressure sensitive region D1 of the diaphragm, and similarly, the region further toward the inside from the non-bonded region S2b on the bottom face of the sensor diaphragm 11-1 is used as the pressure sensitive region D2 of the diaphragm. One measurement pressure Pa is applied to the face that faces the stopper member 11-2 in the pressure sensitive region D1 of the diaphragm, and the other measurement pressure Pb is applied to the face that faces the stopper member 11-3 in the pressure sensitive region D2 of the diaphragm. Note that the diameter of the pressure sensitive regions D1 and D2 is the effective diameter of the diaphragm.

In pressure sensor chip 11A, if the measurement pressure Pa is the high-pressure-side measurement pressure and the measurement pressure Pb is the low-pressure-side measurement pressure, then when the high-pressure-side measurement pressure Pa is applied to the pressure sensitive region D1 on the top face of the sensor diaphragm 11-1, the sensor diaphragm 11-1 can flex without the production of an excessive tensile stress, due to the constraint from the stopper member 11-2, at the non-bonded region S1b that is not bonded to the peripheral edge portion 11-2c of the stopper member 11-2, thus reducing the stress that is produced in this part.

Moreover, the concentration of stresses in the diaphragm edge is prevented because the stresses are dispersed in the interior of the ring-shaped groove 11-2d that is continuous with the non-bonded region S1b. In particular, if the excessively large pressure becomes larger after the sensor diaphragm 11-1 has arrived at the bottom of the recessed portion 11-3a of the stopper member 11-3, the effects through dissipating the stresses within the ring-shaped groove 11-2d will be large.

Moreover, in pressure sensor chip 11A, if the measurement pressure Pb is the high-pressure-side measurement pressure and the measurement pressure Pa is the low-pressure-side measurement pressure, then when the high-pressure-side measurement pressure Pb is applied to the pressure sensitive region D2 on the bottom face of the sensor diaphragm 11-1, the sensor diaphragm 11-1 can flex without the production of an excessive tensile stress, due to the constraint from the stopper member 11-3, at the non-bonded region S2b that is not bonded to the peripheral edge portion 11-3c of the stopper member 11-3, thus reducing the stress that is produced in this part.

Moreover, the concentration of stresses in the diaphragm edge is prevented because the stresses are dispersed in the interior of the ring-shaped groove 11-3d that is continuous with the non-bonded region S2b. In particular, if the excessively large pressure becomes larger after the sensor diaphragm 11-1 has arrived at the bottom of the recessed portion 11-2a of the stopper member 11-2, the effects through dissipating the stresses within the ring-shaped groove 11-3d will be large.

Note that while in the present example, the cross-sectional shape that is perpendicular to the non-bonded regions S1b and S2b of the peripheral edge portions 11-2c and 11-3c of the stopper members 11-2 and 11-3 of the ring-shaped grooves 11-2d and 11-3d is circular, it need not necessarily be circular.

For example, as illustrated in FIG. 2, they may be provided as slit-shaped (a rectangular cross-section) ring-shaped grooves 11-2d1 and 11-3d1, or as illustrated in FIG. 3, they may be provided as L-shaped (L-shaped cross-section) ring-shaped grooves 11-2d2 and 11-3d2. Moreover, while the actual fabrication thereof may not be possible, they may even be provided as semicircular (semicircular cross-section) ring-shaped grooves, as illustrated in FIG. 4.

With the slit-shaped ring-shaped grooves 11-2d1 and 11-3d1, when the high-pressure measurement pressure Pb is applied to the pressure sensitive region D2 of the sensor diaphragm 11-1, then, as illustrated as the points P1 through P5 in FIG. 2, the stress is distributed to the interior of the slit-shaped ring-shaped grooves 11-2d1 and 11-3d1.

With the L-shape ring-shaped grooves 11-2d2 and 11-3d2, when the high-pressure measurement pressure Pb is applied to the pressure sensitive region D2 of the sensor diaphragm 11-1, then, as illustrated by the points P1 through P3 in FIG. 3, the stress is distributed within the L-shaped ring-shaped groove 11-3d2. In this case, the parts 11-2e and 11-3e where the sensor diaphragm 11-1 is held between the L-shaped ring-shaped grooves 11-2d2 and 11-3d2 deform, becoming a two-stage diaphragm structure.

FIG. 5 shows the proportions of stress produced in the diaphragm edge portions, comparing the structure with the non-bonded portion (the structure illustrated in FIG. 1, a structure wherein no ring-shaped groove is provided), a slit structure (the structure illustrated in FIG. 2), a two-stage diaphragm structure (the structure illustrated in FIG. 3), and a vertical R structure (the structure illustrated in FIG. 1), with the case of the conventional structure (the structure illustrated in FIG. 11) defined as 100%. As can be understood from the result of the comparison, the stresses produced in the diaphragm edges are mitigated through not just the non-bonded portion, but also through a slit structure, a two-stage diaphragm structure, or a vertical R structure. With the vertical R structure, the proportion of generated stress, relative to the conventional structure, is small, at about 36%, and thus the result is particularly good.

This makes it possible to ensure the anticipated withstand pressure in the pressure sensor chip 11A according to the present example through preventing concentration of stresses in diaphragm edges through reducing the occurrence of stresses due to constraints on the sensor diaphragm 11-1. Furthermore, in the pressure sensor chip 11A, when there is a mismatch in the opening sizes of the recessed portions 11-2a and 11-3a of the stopper members 11-2 and 11-3, this resolves the misalignment of the locations of constraints on the sensor diaphragm 11-1, and greatly mitigating the resulting increase in stress and production of stress due to a fault when arriving at the bottom.

### Another Example

While in the Example stopper members were provided on both sides of the sensor diaphragm 11-1, if the side of the sensor diaphragm 11-1 that is to bear the high-pressure-side measurement pressure can be determined reliably, then the stopper member need be provided only on the surface (the low-pressure-side measurement pressure bearing surface) that is on the side that is opposite from the surface that bears the high-pressure side measurement-pressure, and a simple retaining member may be provided at the side that bears the high-pressure-side measurement pressure. The structure of such a pressure sensor chip is illustrated as Another Example in FIG. 6.

In this pressure sensor chip 11B, the measurement pressure Pb is determined reliably as the high-pressure-side measurement pressure, so the stopper member 11-2 is provided on only the one face of the sensor diaphragm 11-1 that bears the low-pressure-side measurement pressure Pa, and a simple retaining member 11-6 is provided on the other surface of the sensor diaphragm 11-1 that bears the high-pressure-side measurement pressure Pb. That is, while the stopper member 11-2 has a recessed portion 11-2a that is a curved surface that follows the deformation of the sensor diaphragm 11-1, the recessed portion 11-6a of the retaining member 11-6 does not have such a curved surface, and does not function as a member to protect against an excessively high pressure.

Moreover, in this pressure sensor chip 11B, the peripheral edge portion 11-2c of the stopper member 11-2 is directly bonded, on the entire surface thereof, to one side of the sensor diaphragm 11-1, while, in contrast, in the peripheral edge portion 11-6c of the retaining member 11-6, of the region S3 that faces the other surface of the sensor diaphragm 11-1, the region S3a on the outer peripheral side is a bonded region that is bonded to the other surface of the sensor diaphragm 11-1, and the region S3b that is on the inner peripheral side is a non-bonded region that is not bonded to the other side of the sensor diaphragm 11-1.

Moreover, in the pressure sensor chip 11B a ring-shaped groove 11-6d that extends in the direction of thickness of the retaining member 11-6 that is continuous with the non-bonded region S3b of the peripheral edge portion 11-6c is formed in the peripheral edge portion 11-6c of the retaining member 11-6.

With this pressure sensor chip 11B the measurement pressure Pb is determined reliably as the high-pressure-side measurement pressure, and thus the sensor diaphragm 11-1 flexes only to the side with the recessed portion 11-2a of the stopper member 11-2. In this case, the sensor diaphragm 11-1 can flex without producing an excessive tensile stress, due to constraints by the retaining member 11-6, at the non-bonded region S3b that is not bonded to the peripheral edge portion 11-6c of the retaining member 11-6, reducing the stress that is produced in this part. Moreover, the concentration of stresses in the diaphragm edge is prevented because the stresses are dispersed in the interior of the ring-shaped groove 11-6d that is continuous with the non-bonded region S3b.

### Yet Another Example

While in the Example the non-bonded region S1b of the peripheral edge portion 11-2c of the stopper member 11-2 and the non-bonded region S2b of the peripheral edge portion 11-3c of the stopper member 11-3 were formed through roughening the surface using a plasma, a chemical solution, or the like, instead they may be formed as fine steps that are established with no more than a specific ratio relative to the thickness of the sensor diaphragm 11-1. The structure of such a pressure sensor chip is shown as Yet Another Example in FIG. 7.

In the pressure sensor chip 11E illustrated in FIG. 7, the non-bonded region S1b of the peripheral edge portion 11-2c of the stopper member 11-2 is given a step height h1, to be a region that does not contact the one face of the sensor diaphragm 11-1. Moreover, the non-bonded region S2b of the peripheral edge portion 11-3c of the stopper member 11-3 is given a step height h2, to be a region that does not contact the other face of the sensor diaphragm 11-1.

The step heights h1 and h2 that form the non-bonded regions S1b and S2b of the peripheral edge portions 11-2c and 11-3c of the stopper members 11-2 and 11-3 are established as extremely small step heights of no more than a specific proportion of the thickness of the sensor diaphragm 11-1, due to the relationship between the proportion (%) of the step in relation to the thickness of the diaphragm and the proportion (%) of the maximum primary stress in relation to the fracture stress, illustrated in FIG. 8.

In FIG. 8, the vertical axis is an axis showing the proportion (%) of the maximum primary stress in relation to the fracture stress, where the theoretical value of the material strength is set to 100%. The horizontal axis is an axis showing the proportion (%) of the step height relative to the thickness of the diaphragm. The graph presented in FIG. 8 was produced experimentally. From this graph it is understood that when the proportion of the step height relative to the thickness of the diaphragm becomes large, the proportion of the maximum primary stress relative to the fracture stress becomes large. In this example, when the proportion of the step height relative to the thickness of the diaphragm is 1.95%, the proportion of the maximum primary stress in relation to the fracture stress goes to 100%. Given this, in the present example the proportion of the step height in relation to the thickness of the diaphragm is set to less than 1.95%. For example, if the thickness of the sensor diaphragm 11-1 is 30 μm, then the allowable limit value for the step heights h1 and h2 would be 0.585 μm (an analytical value).

Moreover, while in the example set forth above the ring-shaped groove 11-2d that is provided in the peripheral edge portion 11-2c of the stopper member 11-2 and the ring-shaped groove 11-3d that is provided in the peripheral edge portion 11-3c of the stopper member 11-3 have identical cross-sectional shapes and are provided facing the identical position, as typified by the pressure sensor chip 11A illustrated in FIG. 1, instead the cross-sectional shapes of the ring-shaped grooves 11-2d and 11-3d may be varied, and the positions, in the crosswise direction, of the ring-shaped grooves 11-2d and 11-3d may be different. Moreover, the cross-sectional shapes of the ring-shaped grooves 11-2d and 11-3d are not limited to the circular, slit, or L shapes described above, but rather various different shapes, such as an elliptical shape, may be considered.

Moreover, while in the examples set forth above the sensor diaphragm 11-1 was of a type wherein a strain resistance gauge was formed wherein there is a change in resistance value in accordance with the change in pressure, the sensor chip may be of an electrostatic capacitance type instead. An electrostatic capacitance sensor chip has a substrate that is provided with a specific space (a capacitance chamber), a diaphragm that is provided on the space of the substrate, a stationary electrode that is formed on the substrate, and a movable electrode that is formed on the diaphragm. When the diaphragm deforms due to the application of pressure, the distance between the movable electrode and the stationary electrode changes, causing a change in the electrostatic capacitance over that space.

### Examples

While the present invention has been explained above in reference to examples, the present invention is not limited to the examples set forth above. The structures and details in the present invention may be varied in a variety of ways, as can be understood by one skilled in the art, within the scope of technology in the present invention. Moreover, the present invention may be embodied through combining the various examples, insofar as there are no contradictions.

1. A pressure sensor chip comprising:
a sensor diaphragm that outputs a signal in accordance with a difference in pressures applied to one face and to another face; and
first and second retaining members, which face and are bonded to the peripheral edge portions of the one face and the other face of the sensor diaphragm, wherein:
in the peripheral edge portion of the first retaining member, of the region facing the one face of the sensor diaphragm the region on the outer peripheral side is a bonded region that is bonded to the one face of the sensor diaphragm, and the region on the inner peripheral side is a non-bonded region that is not bonded to the one face of the sensor diaphragm;
in the peripheral edge portion of the first retaining member, a ring-shaped groove is formed protruding in the direction of the wall thickness of the first retaining member, continuous with the non-bonded region of the peripheral edge portion; and
the second retaining member is provided with a recessed portion that prevents excessive dislocation of the sensor diaphragm when an excessively large pressure is applied to the sensor diaphragm.

2. The pressure sensor chip as set forth in claim 1, wherein:
in the ring-shaped groove that is continuous with the non-bonded region on the peripheral edge portion of the first retaining member, the cross-sectional shape of the intersection with the non-bonded region in the peripheral edge portion of the first retaining member includes a circular arc part.

3. The pressure sensor chip as set forth in claim 1, wherein:
the sensor diaphragm uses the one face as a pressure bearing face for a high-pressure-side measurement pressure, and uses the other face as the pressure bearing face for a low-pressure-side measurement pressure.

4. The pressure sensor chip as set forth in claim 1, wherein:
the first retaining member is provided with a recessed portion that prevents excessive dislocation of the sensor diaphragm when an excessively large pressure is applied to the sensor diaphragm;
in the peripheral edge portion of the second retaining member, of the region facing the other face of the sensor diaphragm the region on the outer peripheral side is a bonded region that is bonded to the other face of the sensor diaphragm, and the region on the inner peripheral side is a non-bonded region that is not bonded to the other face of the sensor diaphragm; and
in the peripheral edge portion of the second retaining member, a ring-shaped groove is formed protruding in the direction of the wall thickness of the second retaining member, continuous with the non-bonded region of the peripheral edge portion.
